(19) United States
(12) Patent Application Publication
(10) Pub. No.: US 2016/0124224 A1
(43) Pub. Date: May 5, 2016

(54) DASHBOARD SYSTEM FOR VEHICLE

(71) Applicant: KOREA HITEK CO., LTD., Gyeonggi-do (KR)

(72) Inventor: Myung Il MOON, Hwaseong-si (KR)

(21) Appl. No.: 14/896,352

(22) PCT Filed: Feb. 14, 2014
(86) PCT No.: PCT/KR2014/001213

§ 371 Date: Dec. 4, 2015

(30) Foreign Application Priority Data
Jun. 5, 2013 (KR) 10-2013-0064382

(51) Int. Cl. G02B 27/01; B60K 37/02

(52) U.S. Cl. CPC G02B 27/0101; B60K 37/02; B60K 2350/1064; B60K 2350/1092; B60K 2350/90; B60K 2350/20; G02B 2027/0141; G02B 2027/014

(57) ABSTRACT

Provided is a dashboard system for a vehicle, including: a dashboard cluster adopted to display vehicle information; an HUD (Head Up Display) cluster controlling unit adopted to receive data of sensors installed in a vehicle from an ECU (Electronic Control Unit) and to calculate the vehicle information; and an HUD projector adopted to project the vehicle information calculated by the HUD cluster controlling unit on the dashboard cluster so that the vehicle information can be displayed.

### TECHNICAL FIELD

The present invention relates to dashboard systems for vehicles, and more particularly, to a dashboard system for a vehicle capable of enhancing visibility and improving stability of a user while driving.

### BACKGROUND ART

In general, a dashboard (cluster) on which various pieces of information related to a driving state are displayed has been installed in a vehicle.

The dashboard is composed of a speedometer, a fuel gauge, a thermometer, and various warning lights and the like and allows a driver to drive safely by checking a current driving state of the vehicle.

Accordingly, the dashboard is installed at a position corresponding to a front part of a vehicle on which a driver can easily put his or her eye while driving.

Meanwhile, a head up display (HUD) has been recently favoured as a medium for effectively transmitting vehicle driving information and surrounding situation information to drivers.

The HUD of a vehicle is a display device providing vehicle driving information or other information to a front surface of a driver while driving, namely, a front glass of the vehicle in the scope that does not deviated from the driver's main visual field. The HUD was installed in a plane, particularly, a fighter in the initial stage, and has been recently also installed in a vehicle.

However, the head up display (HUD) is problematic in that a driver's visual field is obstructed while driving due to overlapping with front views.

### DISCLOSURE OF INVENTION

### Technical Problem

Accordingly, the present invention has been made keeping in mind the above problems occurring in the related art. An object of the present invention is to provide a dashboard system for a vehicle that can have improved visibility compared a conventional mechanical or electronic dashboard, can provide various pieces of information, and can prevent a driver from obstructing his or her field of vision due to overlapping with front views caused by a head up display while driving.

In addition, another object of the present invention is to provide a dashboard system for a vehicle that is configured such that more suitable vehicle information screens for users are provided according to various driving environments so that the users' driving concentration can be increased.

Also, a further object of the present invention is to provide a dashboard system for a vehicle that is configured such that an arrangement and the like of the vehicle information may be edited or an image magnitude of the vehicle information projected from and displayed by the HUD projector may be adjusted so that various vehicle information screens can be configured according to each user's preference.

### Solution to Problem

In order to solve the problems, according to an aspect of the present invention, there is provided a dashboard system for a vehicle, including: a dashboard cluster adopted to display vehicle information; an HUD (Head Up Display) cluster controlling unit adopted to receive data of sensors installed in a vehicle from an ECU (Electronic Control Unit) and to calculate the vehicle information; and an HUD projector adopted to project the vehicle information calculated by the HUD cluster controlling unit on the dashboard cluster so that the vehicle information can be displayed.

According to another embodiment of the present invention, the dashboard cluster may include an HUD panel, and the HUD projector projects the calculated vehicle information on the HUD panel so that the vehicle information can be displayed.

According to still another embodiment of the present invention, the dashboard system may further include a navigation processing unit adopted to provide location information and map information of the vehicle.

According to still another embodiment of the present invention, the HUD projector may display the location information and map information of the vehicle received from the navigation processing unit on the dashboard cluster.

According to still another embodiment of the present invention, the vehicle information may include at least one of speed information, mileage information, refueling information, battery information of the vehicle, and vehicle breakdown information.

According to still another embodiment of the present invention, the dashboard system may further include a setting input unit adopted to edit or set the vehicle information displayed by the HUD projector.

According to still another embodiment of the present invention, the setting input unit may adjust an image magnitude of the vehicle information projected from and displayed by the HUD projector.

### Advantageous Effects of Invention

According to the present invention, the dashboard system for a vehicle may have improved visibility compared a conventional mechanical or electronic dashboard and may various pieces of information and may prevent a driver from obstructing his or her field of vision due to overlapping with front views caused by head up display while driving.

In addition, according to the present invention, more suitable vehicle information screens for users are provided according to various driving environments so that the users' driving concentration can be increased.

Furthermore, according to the present invention, an arrangement and the like of the vehicle information may be edited or an image magnitude of the vehicle information projected from and displayed by the HUD projector may be adjusted so that various vehicle information screens can be configured according to each user's preference.

### BRIEF DESCRIPTION OF DRAWINGS

FIG. 1 is a block diagram showing a dashboard for a vehicle according to an embodiment of the present invention;

FIGS. 2 and 3 are views for explaining an appearance and an operation method of the dashboard for a vehicle according to the embodiment of the present invention; and

FIGS. 4 to 6 are views illustrating vehicle information screens provided by the dashboard system for a vehicle to the embodiment of the present invention.

### MODE FOR THE INVENTION

Hereinafter, embodiments of the present invention will be described in detail with reference to the accompanying drawings. In the following description, it is to be noted that, when the functions of conventional elements and the detailed description of elements related with the present invention may make the gist of the present invention unclear, a detailed description of those elements will be omitted. Furthermore, it should be understood that the shape and size of the elements shown in the drawings may be exaggeratedly drawn to provide an easily understood description of the structure of the present invention rather than reflecting the actual sizes of the corresponding elements.

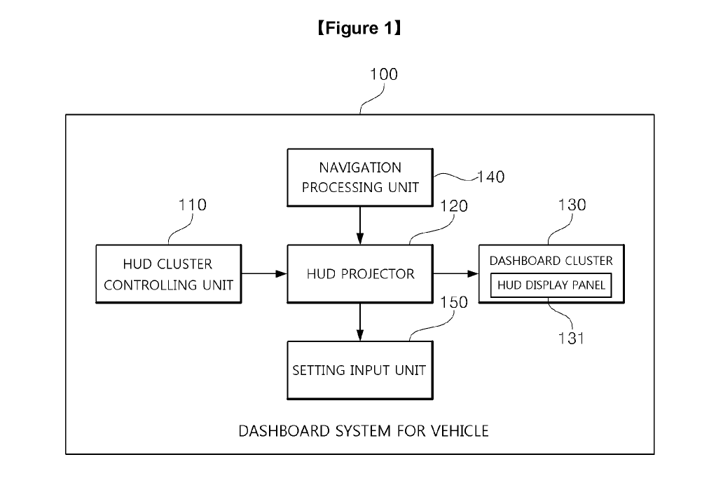

FIG. 1 is a block diagram showing a dashboard for a vehicle according to an embodiment of the present invention.

A dashboard system for a vehicle according to an embodiment of the present invention will be described with reference to FIG. 1.

As illustrated in FIG. 1, the dashboard system for a vehicle 100 according to the embodiment of the present invention includes: an HUD (Head Up Display) cluster controlling unit 110; a HUD (Head Up Display) projector 120; and a dashboard cluster 130.

In addition, the dashboard system for a vehicle 100 according to the embodiment of the present invention may further include: a navigation processing unit 140 and a setting input unit 150.

The HUD Cluster controlling unit 110 receives the data of sensors installed in a vehicle from an ECU (Electronic Control Unit).

In greater detail, the ECU (Electronic Control Unit) receives various kinds of data of the vehicle measured by various sensors installed in the vehicle and transmits the received data of the vehicle to the HUD cluster controlling unit 120.

The HUD cluster controlling unit 110 performs the arithmetic operation of vehicle information using the received data. In this case, the HUD cluster controlling unit 110 may calculate a speed of the vehicle using speed data sensed by a speed sensor of the vehicle or may directly receive the speed data of the vehicle from the speed sensor of the vehicle.

The HUD projector 120 displays of the vehicle information calculated by the HUD cluster controlling unit 110 through control of the HUD cluster controlling unit 110.

The HUD projector 120 projects the vehicle information on the dashboard cluster 130 so that the vehicle information can be displayed. The HUD projector 120 may include a general beam projector.

In this case, the dashboard cluster 130 includes an HUD panel 131. The HUD projector 120 projects the vehicle information on the HUD panel 131 so that the vehicle information can be displayed.

The vehicle information displayed on the HUD panel 131 may include at least one of speed information, mileage information, refueling information, battery information of the vehicle, and vehicle breakdown information or may include various pieces of vehicle information as needed.

Meanwhile, the HUD cluster controlling unit 110 according to the present invention may control the HUD projector 120 so that the HUD projector can provide the most suitable vehicle information among pre-stored vehicle information images according to various surrounding environments sensed by sensors.

In addition, the dashboard system for a vehicle 100 according to the present invention further includes the navigation processing unit 140.

The navigation processing unit 140 provides location information of and map information of the vehicle. Thus, the HUD projector 120 may display the location information and the map information of the vehicle received from the navigation processing unit 140 on the HUD panel 131 of the dashboard cluster 130.

Meanwhile, the dashboard system for a vehicle 100 according to the present invention may further include a setting input unit 150.

The setting input unit 150 may edit and set the vehicle information displayed by the HUD projector. The setting input unit 150 may be formed in a an operational button form on a steering wheel for the convenience of a user, or may be installed at other positions in the vehicle

The setting input unit 150 may be configured to adjust an image magnification of the vehicle information projected from and displayed by the HUD projector 120, to edit an arrangement and the like of the vehicle information, or to change the vehicle information to vehicle information indication formats in variously pre-stored styles.

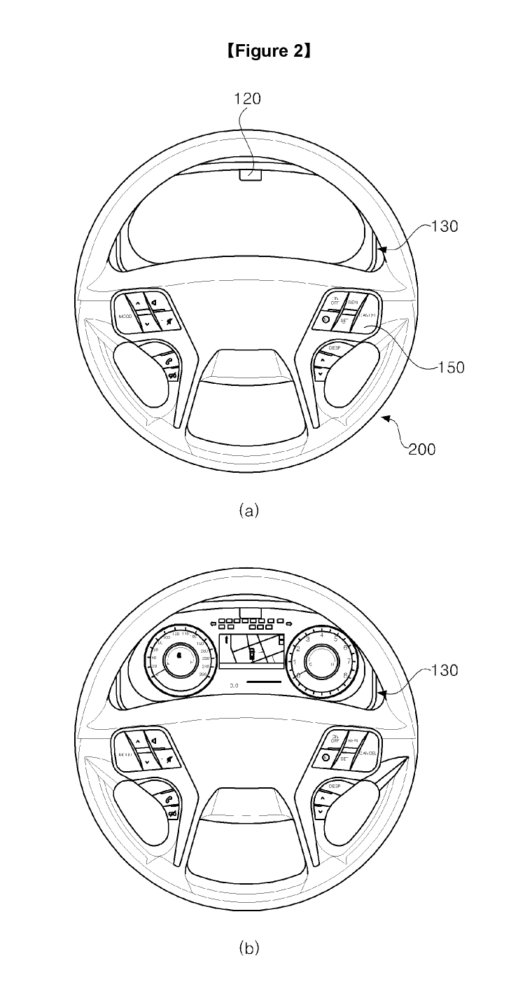

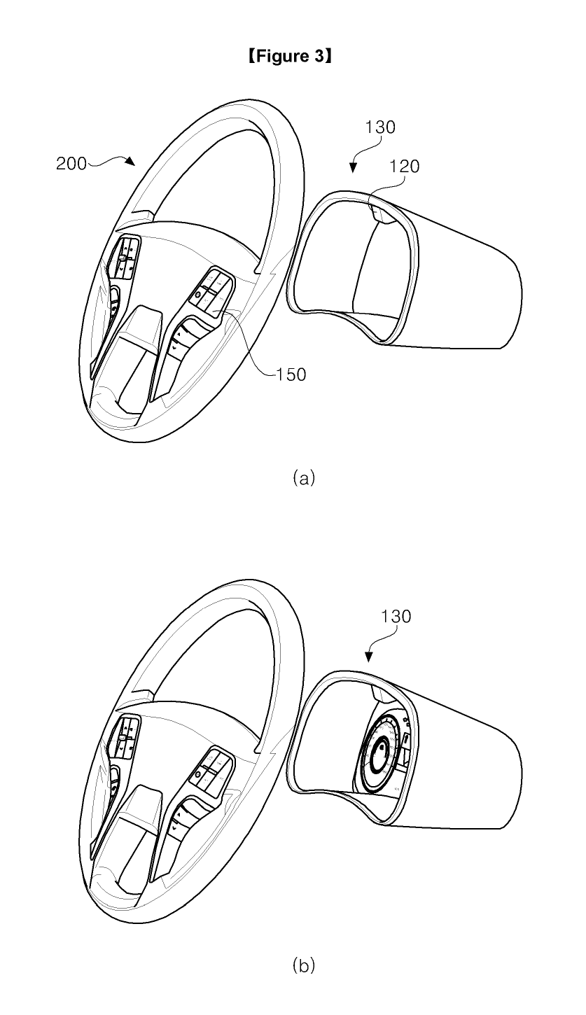

FIGS. 2 and 3 are views for explaining an appearance and an operation method of the dashboard for a vehicle according to the embodiment of the present invention.

As illustrated in (a) of FIG. 2 and (a) of FIG. 3, the dashboard cluster 130 of the dashboard system for a vehicle is disposed on a rear surface of a steering wheel 200, and as illustrated in (b) of FIG. 2 and (b) of FIG. 3, the vehicle information is displayed on the dashboard cluster 130.

In this case, the dashboard system for a vehicle may be configured to display the vehicle information on the dashboard cluster 130 when the user starts the vehicle or drives the vehicle.

The HUD projector 120 may be disposed at a position corresponding to one side of the dashboard cluster 130, and as illustrated in (a) of FIG. 2 and (a) of FIG. 3, the HUD projector 120 may be disposed at a position corresponding to an upper end of the dashboard cluster 130.

Alternatively, the HUD projector 120 may be disposed at various positions that enable the vehicle information to be projected and displayed on the dashboard cluster 130.

As illustrated in (a) of FIG. 2 and (a) of FIG. 3, the setting input unit 150 may be configured to be disposed on the steering wheel 200 for the user's convenience, or may be installed at other position in the vehicle as needed.

As such, when the setting input unit 150 is configured to be disposed on the steering wheel 200, since the vehicle information displayed by the HUD projector 120 may be more conveniently edited and set, various styles of vehicle information indication environments may be provided according to each user's personal preference.

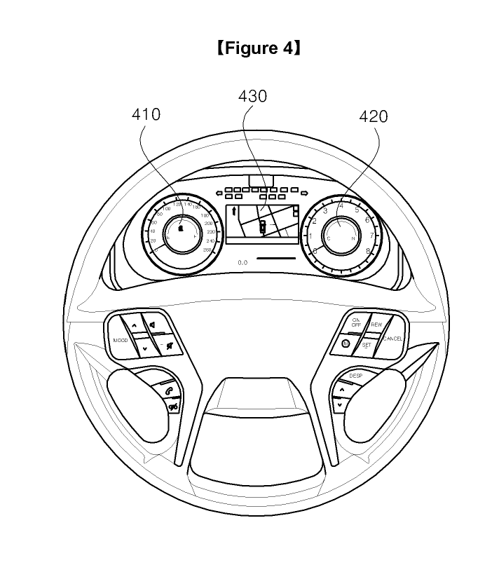

FIGS. 4 to 6 are views illustrating various vehicle information screens provided by the dashboard system for a vehicle to the embodiment of the present invention.

As illustrated in FIG. 4, a vehicle information screen provided by the dashboard system for a vehicle according to the embodiment may include a speedometer 410 of the vehicle, a RPM gauge 420, a navigation screen 430 and the like and may display various pieces of vehicle information in addition thereto.

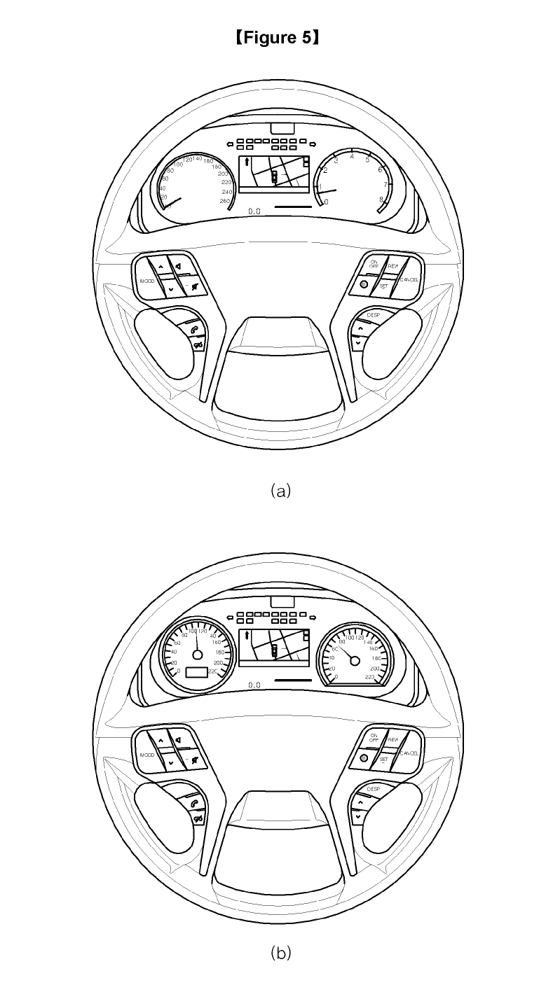

In addition, as illustrated in (a) and (b) of FIG. 5, the vehicle information screen may be changed to various styles of vehicle information indication formats according to each user's preference.

As such, when the vehicle information screen may be set according to the user's selection, a more suitable vehicle information screen for the user may be provided according to various driving environments.

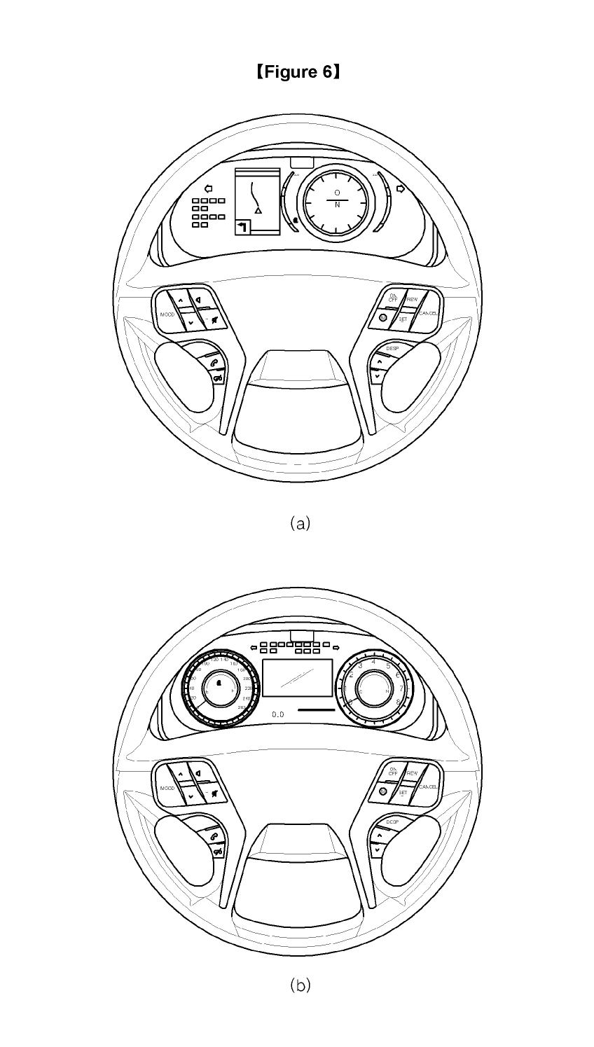

Furthermore, according to the present invention, as illustrated in (a) of FIG. 6, an arrangement and the like of the vehicle information may be edited or an image magnitude of the vehicle information projected from and displayed by the HUD projector may be adjusted so that various vehicle information screens can be configured according to each user's preference.

In addition, as illustrated in (b) of FIG. 6, when the vehicle makes a stop, the screen may be set so that a DMB or video can be watched.

Thus, the dashboard system for a vehicle according to the present invention may have improved visibility compared a conventional mechanical or electronic dashboard and may various pieces of information and may prevent a driver from obstructing his or her field of vision due to overlapping with front views caused by a head up display while driving.

In addition, according to the present invention, more suitable vehicle information screens for users are provided according to various driving environments so that the users' driving concentration can be increased.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

What is claimed is:

1. A dashboard system for a vehicle, comprising:
a dashboard cluster adopted to display vehicle information;
an HUD (Head Up Display) cluster controlling unit adopted to receive data of sensors installed in a vehicle from an ECU (Electronic Control Unit) and to calculate the vehicle information; and
an HUD projector adopted to project the vehicle information calculated by the HUD cluster controlling unit on the dashboard cluster so that the vehicle information can be displayed.

2. The dashboard system of claim 1, wherein the dashboard cluster comprises an HUD panel, and the HUD projector projects the calculated vehicle information on the HUD panel so that the vehicle information can be displayed.

3. The dashboard system of claim 1, further comprising a navigation processing unit adopted to provide location information and map information of the vehicle.

4. The dashboard system of claim 3, wherein the HUD projector displays the location information and map information of the vehicle received from the navigation processing unit on the dashboard cluster.

5. The dashboard system of claim 1, wherein the vehicle information comprises at least one of speed information, mileage information, refueling information, battery information of the vehicle, and vehicle breakdown information.

6. The dashboard system of claim 1, further comprising a setting input unit adopted to edit or set the vehicle information displayed by the HUD projector.

7. The dashboard system of claim 6, wherein the setting input unit adjusts an image magnitude of the vehicle information projected from and displayed by the HUD projector.
